(19) United States
(12) Patent Application Publication
(10) Pub. No.: US 2014/0340590 A1
(43) Pub. Date: Nov. 20, 2014

(54) TOUCH PANEL

(71) Applicant: TIANJIN FUNAYUANCHUANG TECHNOLOGY CO., LTD., Tianjin (CN)

(72) Inventors: PO-SHENG SHIH, New Taipei (TW); YU-JU HSU, New Taipei (TW); CHIH-HAN CHAO, New Taipei (TW); HSUAN-LIN PAN, New Taipei (TW); JIA-SHYONG CHENG, New Taipei (TW)

(73) Assignee: TIANJIN FUNAYUANCHUANG TECHNOLOGY CO.,LTD., Tianjin (CN)

(21) Appl. No.: 13/897,583

(22) Filed: May 20, 2013

(51) Int. Cl. G06F 3/041

(52) U.S. Cl. CPC G06F 3/041
USPC 349/12

(57) ABSTRACT

A touch panel includes a substrate, a first conductive layer and a second conductive layer. The substrate includes a first surface and a second surface opposite with the first surface. The first conductive layer is located on the first surface and includes a plurality of first conductive films located apart from each other. The second conductive layer is located on the second surface and includes a carbon nanotube layer structure. A resistivity of the carbon nanotube layer structure along the first direction is larger than a resistivity of the carbon nanotube layer structure along a second direction perpendicular with the first direction.

### BACKGROUND

1. Technical Field

The disclosure relates to touch panels and, particularly, to a carbon nanotube-based touch panel.

2. Description of Related Art

Various electronic apparatuses such as mobile phones, car navigation systems, and the like, are equipped with optically transparent touch panels applied over display devices such as liquid crystal panels. The electronic apparatus is operated when a contact is made with the touch panel corresponding to elements appearing on the display device. A demand thus exists for such touch panels to maximize visibility and reliability in operation.

A conventional capacitive touch panel often includes two layers of indium tin oxide (ITO) and an insulative layer located between the two layers of indium tin oxide. The ITO layer is generally formed by ion beam sputtering, a relatively complicated process. Furthermore, the ITO layer is rigid, and cannot be etched. Thereby, known processes of making the capacitive touch panel is difficult, and the quality of the touch panel may not be satisfying.

What is needed, therefore, is a touch panel that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic side view of an embodiment of a touch panel.

FIG. 2 is a schematic view of a first conductive layer used in the touch panel of FIG. 1.

FIG. 3 is a schematic view of a second conductive layer used in the touch panel of FIG. 1.

FIG. 4 is a scanning electron microscope (SEM) image of a carbon nanotube film.

FIG. 5 is a schematic view showing calculating touching point in a touch panel.

FIG. 6 is a schematic view of a second conductive layer used in a touch panel of another embodiment.

FIG. 7 is a schematic view of a first conductive layer used in a touch panel of yet another embodiment.

FIG. 8 is a schematic view of a first conductive layer used in a touch panel of still another embodiment.

FIG. 9 is a schematic view of a first conductive layer used in a touch panel of further another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

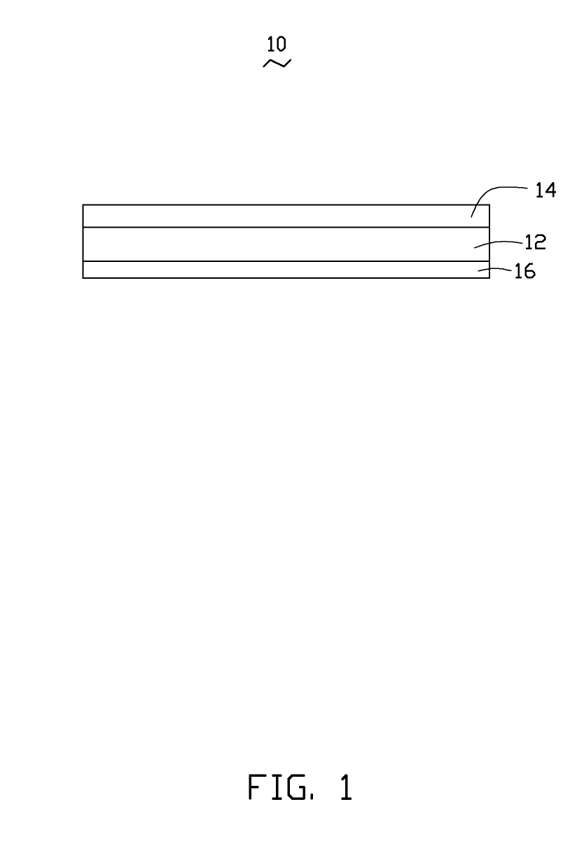

Referring to FIG. 1, one embodiment of a touch panel 10 comprises a first conductive layer 14, a second conductive layer 16 and a substrate 12. The substrate 12 is located between the first conductive layer 14 and the second conductive layer 16. The substrate 12 defines a first surface (not labeled) and a second surface (not labeled) opposite with the first surface. The first conductive layer 14 is attached on the first surface. The second conductive layer 16 is attached on the second surface.

The substrate 12 is configured to support the first conductive layer 14 and the second transparent layer 16. The substrate 12 is a transparent board. The substrate 12 can be made of glass, diamond, quartz, plastic or any other suitable material. The substrate 12 can be made of polycarbonate (PC), polymethyl methacrylate acrylic (PMMA), polyethylene terephthalate (PET), polyethersulfones (PES), polyvinylchloride (PVC), benzocyclobutenes (BCB), polyesters, or acrylic resins. In one embodiment, the substrate 12 is made of glass, and has a thickness of about 2 mm.

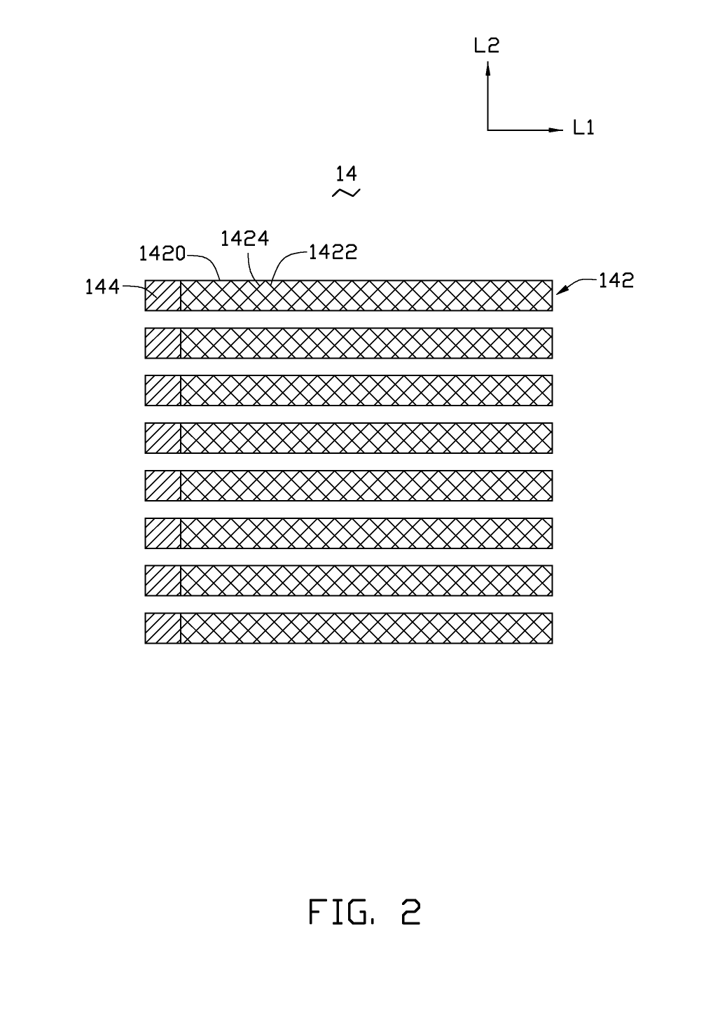

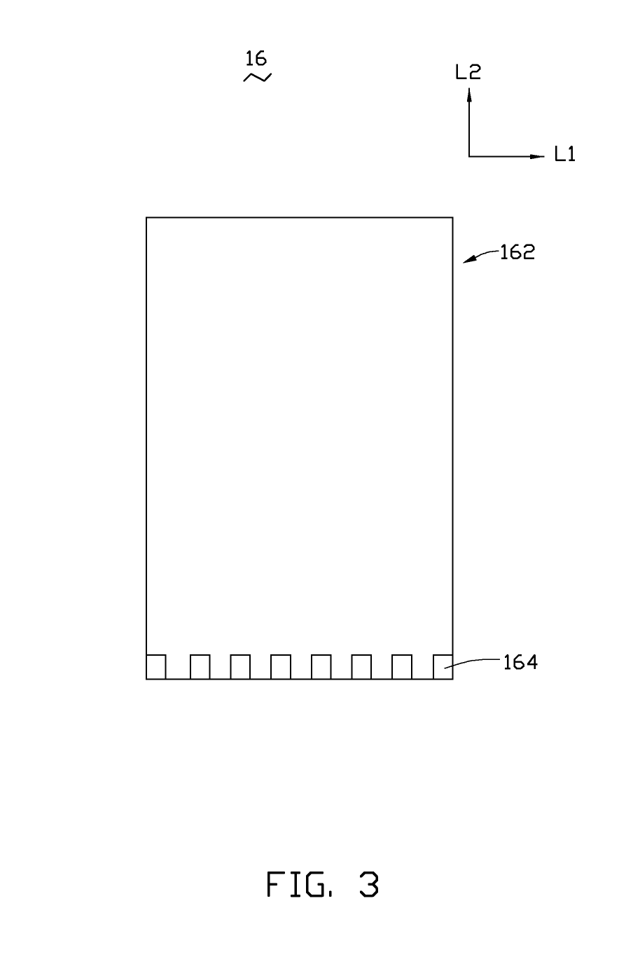

Referring also to FIG. 2, the first conductive layer 14 includes a plurality of first conductive films 142 and a plurality of first electrodes 144. The plurality of first electrodes 144 are electrically connected to the plurality of first conductive films 142. The plurality of first conductive films 142 can be bar-shaped and located apart from each other. The first conductive films 142 can be parallel with each other. In one embodiment, the first conductive films 142 are primarily oriented along the first direction L1 (shown in FIG. 3). The first electrodes 144 are substantially arranged along the second direction L2. The first direction L1 is substantially perpendicular with the second direction L2. A distance between adjacent first conductive films 142 can be uniform or random. The distance can be in a range from about 5 micrometers to about 7 millimeters. In some embodiments, the distance is in a range from about 20 micrometers to about 30 micrometers. A width of each first conductive film 142 can be in a range from about 1 millimeter to about 8 millimeters, especially from about 4 millimeters to about 8 millimeters. A material of the first conductive film 142 can be ITO or conductive polymer.

Each first conductive film 142 includes a plurality of lead wires crossed with each other. In one embodiment according to FIG. 2, the plurality of lead wires in each first conductive film 142 crosses each other to form a net structure. The net structure includes a plurality of pores defined by the lead wires. The net structure includes two edge wires 1420, a plurality of first lead wires 1422, and a plurality of second lead wires 1424. The two edge wires 1420 are located apart from each other and extend along the L1 direction. The plurality of first lead wires 1422 and the plurality of second lead wires 1424 are disposed between the two edge wires 1420. The first lead wires 1422 can be parallel with each other. The second lead wires 1424 can be parallel with each other. Distance between adjacent first lead wires 1422 can be in a range from 5 micrometers to about 2 millimeters. Distance between adjacent second lead wires 1424 can be in a range from 5 micrometers to about 2 millimeters. Diameters of the two edge wires 1420, the plurality of first lead wires 1422 and the plurality of second lead wires 1424 can be almost the same, and in a range from about 5 micrometers to about 2 millimeters. In the embodiment according to FIG. 2, the plurality of first lead wires 1422 and the plurality of second lead wires 1424 are substantially perpendicular with each other. An angle formed between the plurality of first lead wires 1422 and the edge wires 1420 is about 45 degrees. Another angle formed between the plurality of second lead wires 1424 and the edge wires 1420 is about 45 degrees.

The first conductive film 142 defines a first end and a second end opposite with the first end. The plurality of first electrodes 144 can be block-shaped. In the embodiment according to FIG. 2, the plurality of first electrodes 144 is electrically with the first ends of the plurality of first conductive films 142 in a one by one manner. In another embodiment, each first conductive film 142 is electrically connected with two first electrodes 144. That is, one first electrode 144 is electrically connected with the first end of the first conductive film 142, the other first electrode 144 is electrically connected with the second end of the first conductive film 142. As such, each the first conductive film 142 can be electrically connected with outside from the first end and the second end alternatively. The first electrode 144 can be a conductive film made of conductive materials, such as metal, alloy, or indium tin oxide (ITO). In one embodiment, the first electrodes 144 are silver spots made by a screen print method.

The second conductive layer 16 can be a conductive film having different resistance along different directions, e.g., the resistivity of the second conductive layer 16 in two-dimensional space is different. Referring to FIG. 3, the resistivity of the second conductive layer 16 along the first direction L1 is larger than the resistivity of the second conductive layer 16 along the second direction L2.

The second conductive layer 16 can be a carbon nanotube layer structure 162 including a plurality of carbon nanotubes. The carbon nanotube layer structure 162 can be a freestanding structure, that is, the carbon nanotube layer structure 162 can support itself without a substrate. If at least one point of the carbon nanotube layer structure 162 is held, the entire carbon nanotube layer structure 162 can be lifted without being damaged. The plurality of carbon nanotubes in the carbon nanotube structure 162 is substantially oriented along the second direction L2. As such, a conductive passage is formed between each detecting electrode 148 and the second electrode 144. In one embodiment, the carbon nanotube layer structure 162 is a pure structure of carbon nanotubes. The carbon nanotube layer structure 162 can include at least one carbon nanotube film. In one embodiment, the carbon nanotube structure can include at least two stacked carbon nanotube films or a plurality of carbon nanotube films contiguously positioned side by side, with the carbon nanotubes in the carbon nanotube films substantially oriented along the second direction L2.

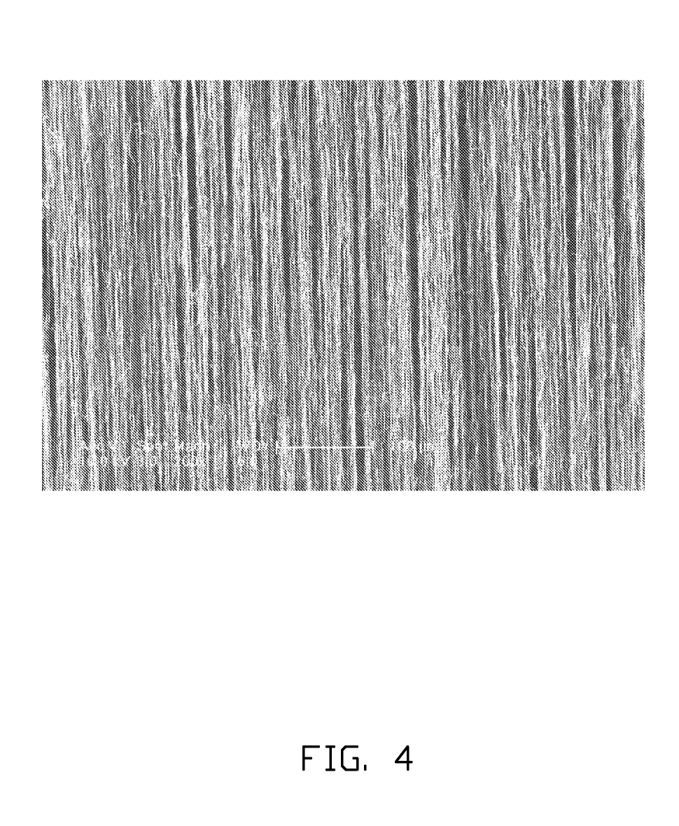

Referring to FIG. 4, the carbon nanotube film includes a number of successive and oriented carbon nanotubes joined end-to-end by van der Waals attractive force therebetween. The carbon nanotube film is a free-standing film. Each carbon nanotube film includes a number of successively oriented carbon nanotube segments joined end-to-end by Van der Waals attractive force therebetween. Each carbon nanotube segment includes a number of carbon nanotubes substantially parallel to each other, and joined by Van der Waals attractive force therebetween. Some variations can occur in the carbon nanotube film. The carbon nanotubes in the carbon nanotube film are oriented along the second orientation L2. The carbon nanotube film can be treated with an organic solvent to increase the mechanical strength and toughness of the carbon nanotube film and reduce the coefficient of friction of the carbon nanotube film. The thickness of the carbon nanotube film can range from about 0.5 nm to about 100 μm.

The second conductive layer 16 further includes a plurality of second electrodes 164 electrically connected with the carbon nanotube layer structure 162. The carbon nanotube layer structure 162 defines a first end and a second end opposite with the first end. The carbon nanotubes in the carbon nanotube layer structure 162 are substantially oriented from the first end to the second end. The plurality of second electrodes 164 can be block-shaped. In the embodiment according to FIG. 3, the plurality of second electrodes 164 is electrically with the first end of the carbon nanotube layer structure 162 and arranged along the first direction L1. In another embodiment, the first end and the second end of the carbon nanotube layer structure 162 are both electrically connected with a plurality of second electrodes 164. The number of the plurality of second electrodes 164 electrically connected with the first end is the same as the number of the plurality of second electrodes 164 electrically connected with the second end. The second electrode 164 can be a conductive film made of conductive materials, such as metal, alloy, or indium tin oxide (ITO). In one embodiment, the second electrodes 164 are silver spots made by a screen print method and attached on a surface of the carbon nanotube layer structure 162.

In one embodiment, a transparent protective film (not shown) can be located on the upper surface of the first conductive layer 14 and/or of second conductive layer 16. The material of the transparent protective film can be silicon nitrides, silicon dioxides, benzocyclobutenes, polyester films, or polyethylene terephthalates. For example, the transparent protective film can be made of slick plastic and receive a surface hardening treatment to protect the first electrode plate 12 from being scratched when in use.

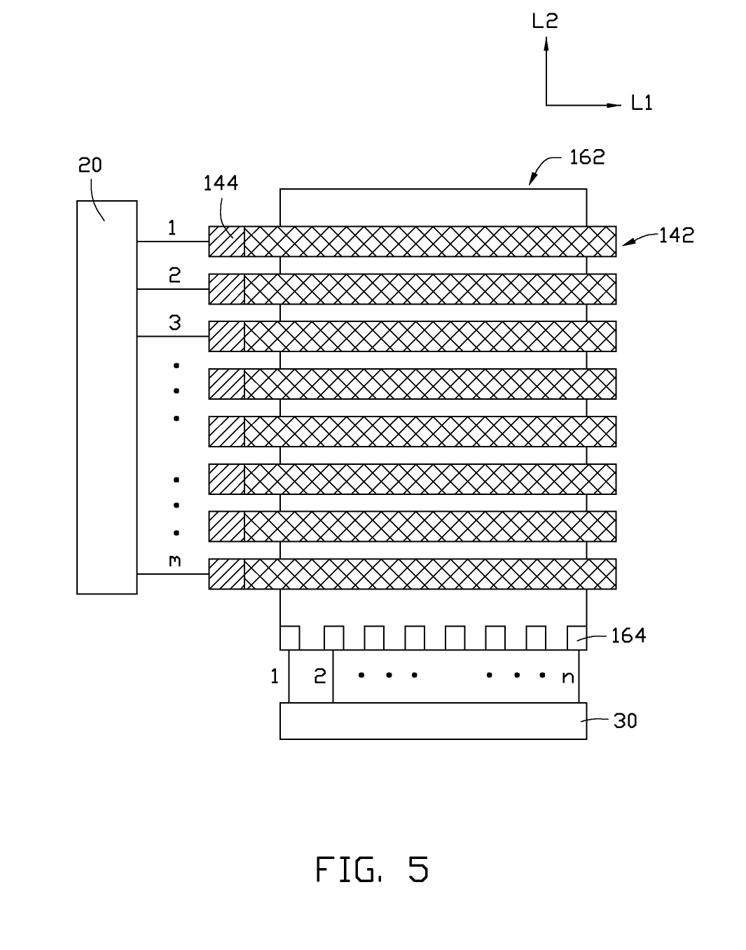

Referring to FIG. 5, the touch panel 10 can further include a driving circuit 20 and a reading circuit 30. The plurality of first electrodes 144 is electrically connected with the driving circuit 20. The plurality of second electrodes 164 is electrically connected with the reading circuit 30. In other embodiment, the plurality of first electrodes 144 can be electrically connected with the reading circuit 30, the plurality of second electrodes 164 is electrically connected with the driving circuit 20.

In use of the touch panel 10, the first conductive layer 14 or the second conductive layer 16 can be adjacent to a touch screen. In one embodiment, the first conductive layer 14 is adjacent with the touch screen. When the touch screen is touched at a touching point, a coupling capacitance between the first conductive layer 14 and the second conductive layer 16 at the touch point is changed, and then the location of the touching point can be calculated by the driving circuit 20 and the reading circuit 30. Referring to FIG. 5, there are m first electrodes 144 electrically connected with the driving circuit 20, and n second electrodes 164 electrically connected with the reading circuit 30. The driving circuit 20 can input signals into the m first electrodes 144 in turn, and the reading circuit 30 can output n values with every first electrode 144. And after one cycle, there are m*n values output. Then the m*n values are calculated and compared, and the location of the touching point can be obtained. When there are several touching points, each touching point corresponds to different first electrode 144 or second electrode 164, and the location of each touching point can also be calculated.

The touch panel 10 disclosed above has the following advantages: the first conductive film 142 has a net structure defining a plurality of pores, and the coupling capacitance between the first conductive layer 14 and the second conductive layer 16 is small. As such, a ratio between the coupling capacitance change at the touching point and the coupling capacitance is large, thereby; coupling capacitance change at the touching point can be detected sensitively. As such, the touch panel 10 has a high sensitivity. Further, the second conductive layer 16 is a carbon nanotube layer structure 162, which is flexible and can be made easily.

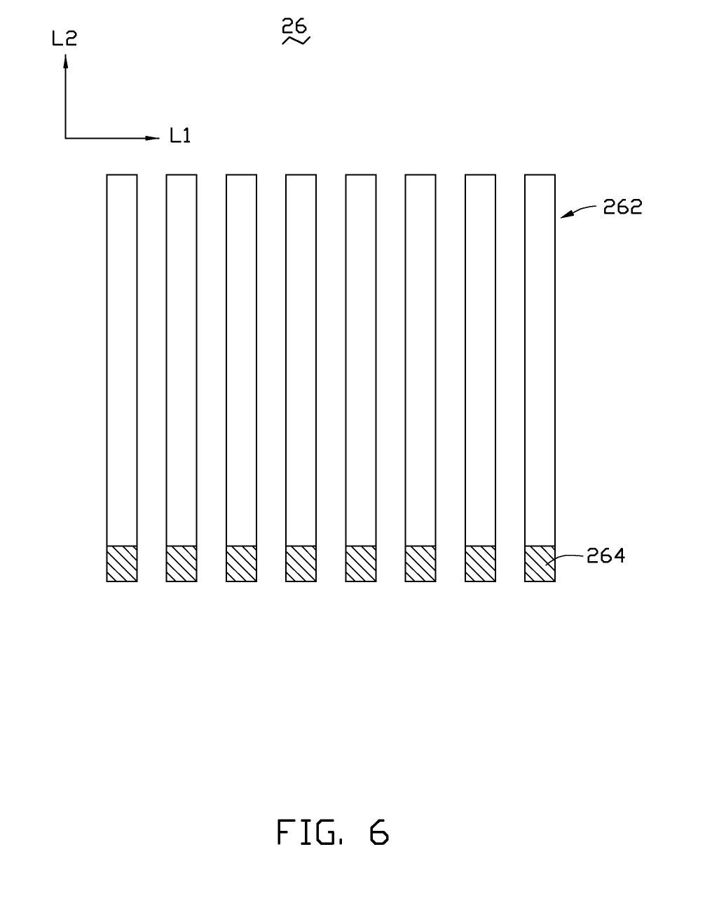

Referring to FIG. 6, a touch panel including a second conductive layer 26 is provided according to another embodiment. The second conductive layer 26 includes a plurality of second conductive films 262. In one embodiment according to FIG. 6, each of the plurality of second conductive films 262 is one carbon nanotube band structure. The carbon nanotube band structure is formed by cutting the carbon nanotube layer structure 162 disclosed above. The plurality of carbon nanotube band structures is located apart from each other. A distance between every adjacent carbon nanotube band structure can be in a range from about 5 micrometers to about 7 millimeters. A width of each carbon nanotube band structure 262 can be in a range from about 3 micrometers to about 8 millimeters. The second conductive layer 26 further includes a number of second electrodes 264 electrically connected with the plurality of carbon nanotube band structure. In the embodiment according to FIG. 6, the number of second electrodes 264 is located at ends of the plurality of carbon nanotube band structure in a one by one manner. The plurality of carbon nanotube band structures is oriented along first direction L1. The carbon nanotubes in the carbon nanotube band structure are substantially oriented along first direction L1.

Other characteristics of the touch panel are the same as the touch panel 10 disclosed above.

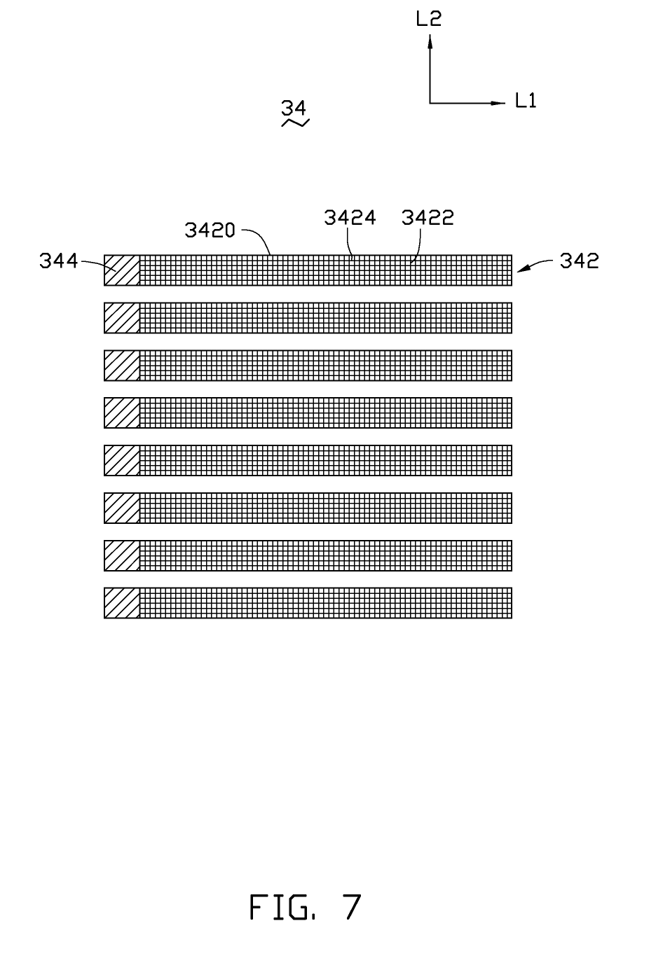

Referring to FIG. 7, a touch panel including a first conductive layer 34 is provided according to yet another embodiment. The first conductive layer 34 includes a plurality of first conductive films 342 and a plurality of first electrodes 344. The plurality of first electrodes 344 are electrically connected to the plurality of first conductive films 342. Each first conductive film 342 includes a plurality of lead wires crossed with each other. In one embodiment according to FIG. 7, the plurality of lead wires in each first conductive film 342 crosses each other to form a net structure. The net structure includes two edge wires 3420, a plurality of first lead wires 3422, and a plurality of second lead wires 3424. The two edge wires 3420 are located apart from each other and extend along the first direction L1. The plurality of first lead wires 3422 and the plurality of second lead wires 3424 are disposed between the two edge wires 3420. The first lead wires 3422 are parallel with each other. The second lead wires 3424 can be parallel with each other. The first lead wires 3422 are substantially parallel with the two edge wires. The first lead wires 3422 are substantially perpendicular with the second lead wires 3424. That is, the second lead wires 3424 are substantially oriented along second direction L2.

Other characteristics of the touch panel are the same as the touch panel 10 disclosed above.

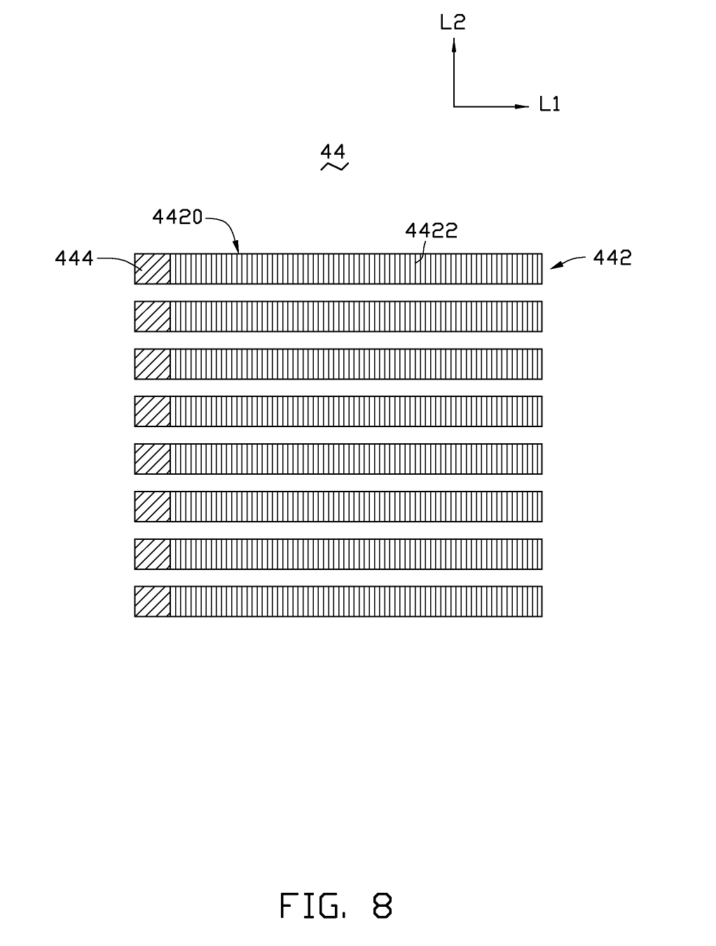

Referring to FIG. 8, a touch panel including a first conductive layer 44 is provided according to further another embodiment. The first conductive layer 44 includes a plurality of first conductive films 442 and a plurality of first electrodes 444. Each first conductive film 442 includes a plurality of lead wires crossed with each other. In one embodiment according to FIG. 8, the plurality of lead wires in each first conductive film 442 crosses each other to form a net structure. The net structure includes two edge wires 4420 and a plurality lead wires 4422. The two edge wires 4420 are located apart from each other and extend along the first direction L1. The plurality of lead wires 4422 is substantially parallel with each other and crossed with the two edge wires 4420. An angle formed between lead wires 4422 and the edge wires 4420 is greater than 0 degrees and less or equal to 90 degrees. In the embodiment according to FIG. 8, the plurality of lead wires 4422 is substantially perpendicular with the two edge wires 4420. A plurality of pores is defined by adjacent lead wires 4422 and the edge wires 4420.

Other characteristics of the touch panel are the same as the touch panel 10 disclosed above.

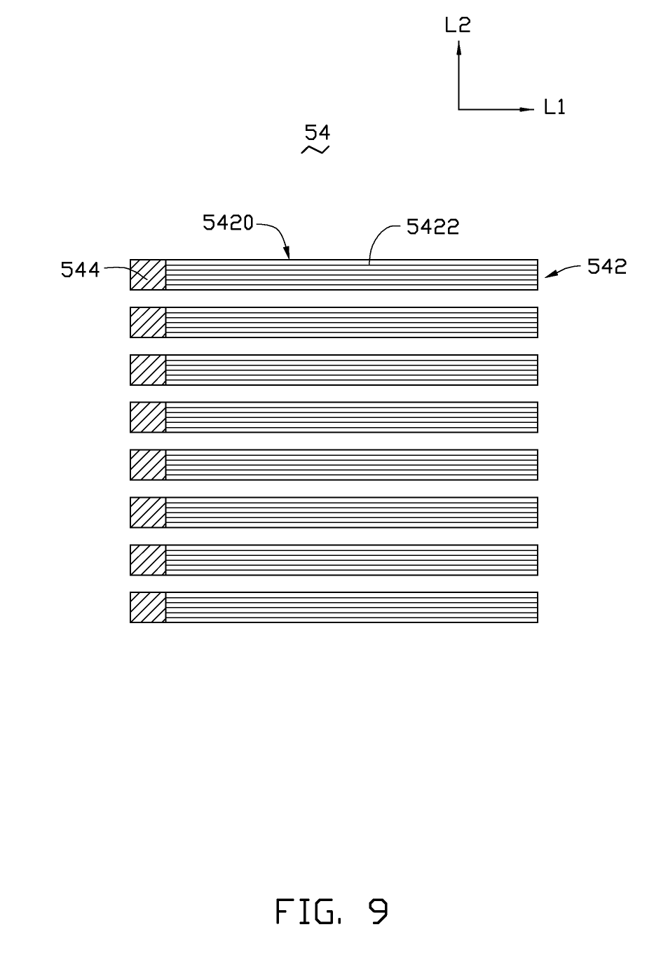

Referring to FIG. 9, a touch panel including a first conductive layer 54 is provided according to still another embodiment. The first conductive layer 54 includes a plurality of first conductive films 542 and a plurality of first electrodes 544. Each first conductive film 542 is a net structure. The net structure includes two edge wires 5420 and a plurality lead wires 5422. The two edge wires 5420 are located apart from each other and extend along the first direction L1. The plurality of lead wires 5422 is substantially parallel with each other and with the two edge wires 4420.

Other characteristics of the touch panel are the same as the touch panel 10 disclosed above.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A touch panel comprising:
a substrate comprising a first surface and a second surface opposite with the first surface;
a first conductive layer located on the first surface and comprising a plurality of first conductive films separated from each other and oriented along a first direction, each of the plurality of first conductive films is a net structure;
a second conductive layer and located on the second surface and comprising a carbon nanotube layer structure;
wherein a resistivity of the carbon nanotube layer structure along the first direction is larger than a resistivity of the carbon nanotube layer structure along a second direction perpendicular with the first direction.

2. The touch panel of claim 1, wherein a distance between adjacent of the first conductive films is in a range from about 5 micrometers to about 7 millimeters.

3. The touch panel of claim 1, wherein a width of each of the plurality of first conductive films is in a range from about 1 millimeter to about 8 millimeters.

4. The touch panel of claim 3, wherein a width of each of the plurality of first conductive films is in a range from about 4 millimeters to about 8 millimeters.

5. The touch panel of claim 1, wherein each of the plurality of first conductive films comprises two edge wires and a plurality of lead wires between the two edge wires and electrically connecting the two edge wires.

6. The touch panel of claim 5, wherein a diameter of each of the two edge wires is the same as a diameter of each of the plurality of lead wires, and is in a range from about 5 micrometers to about 2 millimeters.

7. The touch panel of claim 5, wherein the plurality of lead wires comprises a plurality of first lead wires parallel with each other and a plurality of second lead wires parallel with each other.

8. The touch panel of claim 7, wherein the plurality of first lead wires and the plurality of second lead wires are crossed with each other to form a net structure defining a plurality of pores.

9. The touch panel of claim 7, wherein the plurality of first lead wires is perpendicular with the plurality of second lead wires.

10. The touch panel of claim 5, wherein the plurality of lead wires is parallel with the two edge wires.

11. The touch panel of claim 5, wherein the plurality of lead wires is perpendicular to the two edge wires.

12. The touch panel of claim 1, wherein the carbon nanotube layer structure comprises a plurality of carbon nanotubes oriented along the second direction.

13. The touch panel of claim 1, wherein the plurality of carbon nanotubes is joined end to end by van der Waals attractive force with each other along the oriented direction of the plurality of carbon nanotubes.

14. The touch panel of claim 1, wherein the second conductive layer is a substantially pure structure of carbon nanotubes.

15. The touch panel of claim 1, wherein the second conductive layer comprises a plurality of second conductive films separated from each other and oriented along the second direction.

16. The touch panel of claim 1, further comprising a plurality of first electrodes electrically connected with the first conductive films in a one by one manner and a plurality of second electrodes electrically connected with the second conductive layer.

17. The touch panel of claim 16, wherein the plurality of first electrodes is located at ends of the first conductive films and arranged along the second direction, the plurality of second electrodes is located at one end of the second conductive layer and arranged along the first direction.

18. A touch panel comprising:
a first substrate comprising a first surface and a second surface opposite with the first surface;
a first conductive layer located on the first surface and comprising a plurality of first conductive films separated from each other and oriented along a first direction, each of the plurality of first conductive films is a net structure;
a second conductive layer located on the second surface and comprising a plurality of second conductive films separated from each other and oriented along a second direction, each of the plurality of second conductive films is a carbon nanotube layer structure;
wherein a first direction is perpendicular with the second direction.
